(19) United States
(12) Patent Application Publication
(10) Pub. No.: US 2005/0172985 A1
(43) Pub. Date: Aug. 11, 2005

(54) Method for Stripping Cured Paint from Low Temperature Plastic Substrates

(76) Inventor: Samuel Lee Miles, Rochester Hills, MI (US)

Correspondence Address: SAMUEL L. MILES, 3143 CROOKS ROAD, ROCHESTER HILLS, MI, 48309, US

(21) Appl. No.: 10/708,058

(22) Filed: Feb. 5, 2004

(51) Int. Cl. B08B 3/08

(52) U.S. Cl. 134/38; 134/41; 134/26

(57) ABSTRACT

This invention is an ambient temperature method to strip cured paint from low temperature threshold plastic substrates; in addition, this novel method can be utilized to strip wood, steel, aluminum, brass, magnesium and non-ferrous substrates. A paint stripping composition based on a unique mixture of Boron methoxide, at least one alcohol, at least one surfactant and at least one evaporation inhibitor, at least one alkaline or acid activator and at least one additive and may contain at least one co-solvent and may be utilized as-is, water thin, in an immersion tank or thickened and applied by spray, brush or roller. More specifically, a paint stripping process invented to salvage, recover and recycle reject or sometimes called rework painted production parts, in-tact, without adversely affecting the parts substrate and form.

### CROSS REFERENCE TO RELATED APPLICATIONS

U.S. Pat. No. 5,468,779 ISSUED ON NOV. 21, 1995, YAMAMOTO, ET AL., CLASS 521/46.5. U.S. Pat. No. 5,578,135 ISSUED ON NOV. 26, 1996, LOHR, ET AL., CLASS 134/7. U.S. Pat. No. 6,608,012 ISSUED ON AUG. 19, 2003, MACHAC, JR., ET AL., CLASS 510/212. U.S. Pat. No. 6,660,100 ISSUED ON DEC. 9, 2003, WIEDEMANN, CLASS 134/6.

### BACKGROUND OF INVENTION

The Industrial, Automotive, Appliance, Agricultural and Aircraft Industries paint interior and exterior parts to protect the substrates from corrosion and to enhance the cosmetic appearance to help market the finished product. Most paint finishing manufactures and paint finishing job shops have a zero tolerance for paint defects in the final product. The first pass paint finish many times will not pass the quality inspection. Up to 30% of first pass paint finishes are rejected by the quality inspectors and sent back to be stripped and reprocessed through paint. Reject painted plastic parts are usually sold at a negative value for scrap at salvage costs or crushed into particles to recycle. The present methods for paint removal on rework painted plastic parts has been taught by the following inventors: Yamamoto, et al., in 1995, U.S. Pat. No. 5,468,779 taught a method of paint removal from plastic by first course-crushing the plastic molded parts and utilizing a composition that consists; a heterocylic compound, a triazine compound and a phenylendiamine compound. In 1996, Lohr, et al., taught in U.S. Pat. No. 5,578,135 to first mechanically comminute the plastic molded parts into particles of a pour-able size then circulate in a mixture of anhydrous alkified diethylene glycol or propylene glycol at temperatures of 50 degrees C. to 75 degrees C. In August of 2003, Machac, Jr., et al., in U.S. Pat. No. 6,608,012, teaches methods to remove paint from thermoplastic polyolefin, requiring temperatures of 45 degrees C. to 75 degrees C. with a composition consisting a mixture of a carbonate, a pyrrolidone, a monoester, a ketone, a glycol ether and an organic sulfur containing compound. In December of 2003, Wiedemann, in U.S. Pat. No. 6,660,100, taught first crush the plastic parts in to small pieces prior to paint removal, then immerse the plastic pieces into an emulsion consisting an aqueous mixture of caustic lye and solvent. This invention provides a novel process that may be placed in the paint finishing plant or job shop to strip the cured paint from the molded plastic part in-tact, without grinding the part for waste or partial recycle. The rework plastic painted part can be completely stripped in an as-is condition, at ambient temperatures in 15 minutes to 30 minutes, the rework parts can then be sent back through the paint line for reprocess through paint in a like new condition. Prior art utilized many different compositions and methods to strip the cured paint. Prior art methods to strip cured paint include the following: High pH Caustic Hydroxides, low pH acid solutions that will attack soft base metal substrates such as aluminum, galvanized, brass, zinc and magnesium substrates. High temperature bake ovens operate in the 600° F. to 1200° F. range which would melt plastic and most aluminum parts and often create metal fatigue on steel or adversely affect the life of the part. Abrasives are also used to strip cured paint, many times adversely affecting the substrates surface. Abrasives can not remove cured paint from the parts hidden interior or recessed areas.

### SUMMARY OF INVENTION

The inventor discovered improved methods to chemically strip low temperature plastics, wood, steel, aluminum, brass, magnesium, galvanized steel, zinc and non-ferrous substrates at ambient temperatures with the part in-tact. This novel mixture effectively removes paint by dissolving and undercutting the cured paint film, normally in 15 to 30 minutes. The composition will strip most current paint technologies including, not limited to the following: Electro-Deposition (E-Coat), Powder Coat Technologies, Solvent Borne, Water Borne and Clear Coat Technologies, Lacquer Technologies, Latex Technologies, Epoxy Coating Technologies and Urethane Coating Technologies. This invention is an ambient temperature method to strip cured paint from plastics with low temperature thresholds, in addition to wood, steel, aluminum, brass, magnesium and non-ferrous substrates. A paint stripping composition based on a unique mixture of a boric acid ester, at least one alcohol, at least one surfactant and at least one evaporation inhibitor, at least one alkaline or acid activator and at least one additive and may contain at least one co-solvent and may be utilized as-is, with a water thin viscosity, in an immersion tank or thickened and applied by spray, brush or roller. More specifically, a paint stripping process invented to salvage, recover and recycle reject or sometimes called rework painted production parts, in-tact, without first crushing the plastic part.

### DETAILED DESCRIPTION

This invention is an ambient temperature method to strip cured paint from plastics with low temperature thresholds; in addition, this novel method can be utilized to strip wood, steel, aluminum, brass, magnesium and non-ferrous substrates. A paint stripping composition based on a unique mixture of Boron methoxide and additives comprising: at least one alcohol, at least one surfactant and at least one evaporation inhibitor, at least one alkaline or acid activator and may contain at least one co-solvent and may be utilized as-is, water thin, in an immersion tank or thickened and applied by spray, brush or roller. More specifically, a paint stripping process invented to salvage, recover and recycle reject or sometimes called rework painted production parts, in-tact, without adversely affecting the parts substrate and form.

The composition of this invention consists a Boron methoxide mixture comprising:

a) at least one additive selected from the group of additives consisting; water, organic solvents, alcohols, aliphatic solvents, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof;

b) immersing said cured painted substrate in said strip tank containing said stripping composition; or

c) applying said stripping composition to said cured painted substrate in a thickened form at ambient temperature for approximately 15 minutes to 30 minutes, wherein cured paint is removed from said substrate. This invention was tested for paint removal with present Industrial, Automotive, Wheel, Appliance, Agricultural and Aircraft Industry Paint Technologies. Paint tested was from the following manufactures: Dupont, PPG, Akzo Nobel, BASF, Red Dot, Morton, and Ferro. Paints tested were Powder, E-Coat, Automotive-(E-Coat, Base Coat/Clear Coat), Urethane, Lacquer Results were observed at 15 minutes, 20 minutes and 30 minutes at ambient temperatures. T

The time to completely strip parts for reprocess is provided:

Boron methoxide mixture, parts immersed at ambient temperature. Paint Technologies % Stripped % Stripped % Stripped—15 minutes 20 minutes 30 minutes E-Coat (over steel) 30% 50% 100% Powder Coat (aluminum wheel) 25% 45% 100% Enamel (electro-galvanized) 35% 55% 100% Lacquer (oak wood furniture) 40% 60% 100% Clear Coat (brass handle) 30% 50% 100% Urethane (Plastic Mirror Housing) 90% 100% 100% Base Coat (magnesium) 35% 55% 100% Note: all painted parts had a cured paint film build of 1 to 2 mil. Paint strip results were similar regardless of application methods.

1. a) method to strip cured paint from plastics with low temperature thresholds, and wood, steel, aluminum, brass, magnesium and non-ferrous substrates comprising: a) application of a stripping composition to a cured painted substrate, said stripping composition comprising a mixture of Boron methoxide consisting: at least one alcohol, at least one surfactant and at least one evaporation inhibitor, and may contain at least one additive selected from the group consisting; water, organic solvents, alcohols, aliphatic solvents, polar solvents, nonpolar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof; b) immersing said cured painted substrate in said strip tank containing said stripping composition at ambient temperature for approximately 15 minutes to 30 minutes, wherein cured paint is removed from said substrate; or c) applying said stripping composition on said cured painted substrate in a thickened form at ambient temperature for approximately 15 minutes to 30 minutes, wherein cured paint is removed from said substrate

2. The method of claim 1, wherein said Boron methoxide is in the range of 0.1-99.9 percent by weight.

3. The method of claim 1, wherein said alcohol is in the range of 0.1-99.5 percent by weight.

4. The method of claim 1, wherein said surfactant is in the range of 0.1-99.5 percent by weight.

5. The method of claim 1, wherein said evaporation inhibitor is in the range of 0.1-99.5 percent by weight.

6. The method of claim 1, wherein said additives is in the range of 0.1-99.5 percent by weight.

7. The method of claim 2, wherein said Boron methoxide is selected from the group consisting; alkyl borate, methyl borate azeotrope mixture, boric acid acetate, methyl borate, trimethyl borate, boric acid trimethyl ester, trimethoxyborane, trimethoxyborine, trimethoxyboron, trimethyl borate, trimethylester kyseliny borite in a preferred range of 0.1-97 percent by weight.

8. The method of claim 3, wherein said alcohol is selected from the group consisting; ethanol, methanol, butanol, propanol, pentanol, hexanol, heptane, septanol, octanol, nonanol, decanol, (HGNS) high grade neutral spirits derived from molasses or grain, denatured alcohol, vegetable, plant, grain and wood derived alcohols, industrial methylated spirits, mineralized methylated spirits, organic alcohols, alkyl alcohols, iso alcohols, normal alcohols, secondary alcohols, tertiary alcohols, nonyl alcohols, ethoxylated alcohols, butoxy alcohols, butyl alcohols, carboxylated alcohols, glycol based alcohols, and benzyl alcohols, ethyl acetate alcohol mixtures, butyl acetate alcohol mixtures, propyl acetate alcohol, fatty acid based alcohols, and alcohol mixtures thereof, in a preferred the range of 0.1-50 percent by weight.

9. The method of claim 4, wherein said surfactant is selected from the group consisting; surfactants, non-ionic surfactants, anionic surfactants, cationic surfactants, amphoteric surfactants, acetate based surfactants, acetylene based surfactants, solvent based surfactants, phosphate ester surfactants, acid pH based surfactants, alkaline pH based surfactants, neutral pH surfactants, sulfonic acid surfactants, phosphoric acid surfactants, fatty acid based surfactants, inorganic acid based surfactants, carboxylate based surfactants, alkylate based surfactants, alcohol based surfactants, nonylphenol surfactants, oxide-based surfactants, sulfur based surfactants, alkylphenol containing surfactants, ethoxylated surfactants, sulphonate based surfactants, amine based, amine oxides surfactants, amide surfactants, glycol based surfactants and quaternary surfactants and surfactant mixtures thereof, in a preferred range of 0.1-50 percent by weight.

10. The method of claim 5, wherein said evaporation inhibitor is selected from the group consisting; petroleum oils, organic oils, synthetic oils, mineral oils, vegetable and plant derived oils, animal oils, fish oils, castor oils, waxes, surfactants, fatty acids, slow evaporation cosolvents, water, film forming agents and mixtures thereof, in a preferred range of 0.1-50 percent by weight.

11. The method of claim 6, wherein said additive is selected from the group consisting; water, organic solvents, alcohols, aliphatic solvents, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof, in a preferred range of 0.1-50 percent by weight.
